(19) United States
(12) Patent Application Publication
(10) Pub. No.: US 2012/0037722 A1
(43) Pub. Date: Feb. 16, 2012

(54) ADJUSTABLE IRRIGATION SPRINKLER

(76) Inventors: Haim SHAHAK, Kibbutz Gvat (IL); Daniel Messinger, Migdal Haemek (IL)

(21) Appl. No.: 12/856,907

(22) Filed: Aug. 16, 2010

(51) Int. Cl. B05B 15/10; B05B 3/00

(52) U.S. Cl. 239/206; 239/225.1

(57) ABSTRACT

A programmable sprinkler for even irrigation of a land area of regular or irregular shape having an upper portion having an upper revolvable housing being supported by a non-revolvable adjusting system attached to a non-revolvable mid section provided with a water passage and further having at least one spray nozzle tiltably supported inside the upper revolvable housing, the water jet inlet port of said nozzle being alignable to a water outlet port; an adjustable cam track attached below the spray nozzle to the non-revolvable mid section; a plurality of cam track adjustment means provided, to the cam track for changing the profile thereof; and a connecting rod disposed, inside the upper revolvable housing, and being in sliding or rolling contact at a lower extremity with the adjustable cam track and at the upper extremity being connected and revolving together with the spray nozzle.

### BACKGROUND OF THE INVENTION

Many areas of the globe, including the Middle East, suffer from a shortage of good quality water, a situation which has worsened since the publication in 2007 of our previous patent. While it is true that desalination of seawater can produce any desired quantity of drinking water, such plants take time to build, they require power, capital investment and land for operation and the combined operating and capital costs of the plant are still too high for many agricultural applications, aside from other applications such as the flushing of toilets.

In order to prevent water wastage in irrigation of plants, grass and vegetation the water must be delivered evenly over the area of concern. Using round pattern sprinklers to cover large areas requires an overlapping of the sprinklers pattern in order to irrigate each portion of the area that requires many closed spaced sprinklers, and still, the coverage is not even, some spots get more water then others. A rectangular shape, which immediately poses the difficulty of depositing the water in the corners of the rectangle without wasting water beyond the long mid-sides of the rectangle. A further problem arises when a sprinkler is irrigating a rectangular shape, the distribution of water inside the rectangular shape is not even. In order to avoid this, the watering distance and the sprinkler output must be changed. Even if the area to be irrigated was circular in form the rotating head of the sprinkler if set to deposit the correct amount of water in a circle 10 meters radius, and under the same conditions but in a circle of 5 meters radius, far more water than needed will soak the smaller area. Intense effort has been invested in the development of sprinklers providing good water distribution.

### SUMMARY OF THE INVENTION

The present invention is an improvement on and a development of the applicant's previous invention described in US Patent Application Publication no. US 2009/0152377. incorporated by reference herein. The present Application is related to U.S. patent application Ser. No. 12/785,776, filed on May 24, 2010 and which is incorporated herein by reference.

The invention refers to an irrigation sprinkler which can be adjusted to provide even coverage of areas such as parks, agricultural areas, golf courses and private lawns.

More particularly, the invention provides a sprinkler head and a complete sprinkler assembly which when not in use either remains in place or retracts to ground level so as not to obstruct persons and vehicles, or as non pop-up, portable placed on the ground.

The primary object of the present invention is to achieve improved evenness in water distribution, while irrigating round or non round watering pattern.

It is a further object of the present invention to provide a sprinkler which can be adapted for use on residential, commercial and recreational areas such as golf courses and parks.

Yet a further object is to provide a sprinkler head which can be used as a replacement to be adapted to a stationary part of a fixed or a pop-up sprinkler for the head of either a fixed or a pop-up sprinkler.

Embodiments of the present invention achieve the above objects by providing an improved upper portion of a programmable sprinkler for even irrigation of a land area of regular or irregular shape, said upper portion comprising:
a) an upper revolvable housing arranged to be revolved on a vertical axis driven by a water turbine, or any other means, powered by water entering a lower casing, said upper revolvable housing being supported by a non-revolvable adjusting system attached to a non-revolvable mid section provided with a water passage and further having
b) at least one spray nozzle tiltably supported inside said upper revolvable housing, the water jet inlet port of said nozzle being alignable to a water outlet port;
c) sealing means for the interfacing surfaces of said outlet and inlet ports;
d) an adjustable cam track attached below said spray nozzle to said non-revolvable mid section;
e) a plurality of cam track adjustment means provided with access from an external space, by whatever adjusting means, to said cam track for changing the profile thereof; and
f) a connecting rod disposed, inside said upper revolvable housing, and being in sliding or rolling contact at a lower extremity with said adjustable cam track and at the upper extremity being connected and revolving together with said spray nozzle.

In a preferred embodiment of the present invention there is provided a complete projecting sprinkler unit comprising a fixed base casing provided with a water inlet, said casing supporting an improved upper portion of a programmable sprinkler.

In a further preferred embodiment of the present invention there is provided a complete pop-up sprinkler unit comprising a fixed base casing configured for under ground installation provided with a water inlet, said casing slidingly supporting an improved upper portion of a programmable sprinkler, said sprinkler having a non-revolvable vertically slidable mid section (called by those skilled in the art a “riser”) which is raised on a vertical axis by water under pressure entering said sprinkler and returned to its lower position flush with ground level in response to cessation of said water pressure.

In another preferred embodiment of the present invention there is provided an improved upper portion wherein the flow rate of said sprinkler is increased by automatic improvement of the alignment of said outlet and inlet ports when said nozzle is disposed at a shallow elevation to the horizontal, and automatically of increases misalignment of said ports when said nozzle is disposed at a higher elevation to the horizontal.

In a further preferred embodiment of the present invention there is provided an improved upper portion wherein said sealing means for the interfacing surfaces of said outlet and inlet ports comprises an elastomer low-friction O ring, pressure of the O ring on the nozzle inlet is provided by the water jet coming from the outlet port.

In yet a most preferred embodiment of the present invention there is provided an improved upper portion wherein said plurality of cam adjustment means provided comprises wedge members which are disposed to contact with said adjustable cam track, said wedges being movable from outside said sprinkler and being lockable adjustable by means of screws having outwardly facing heads.

It will thus be realized that the novel sprinkler head of the present invention serves for evenly irrigating an area within its range however shaped. The sprinkler to be described makes use of the unexpected test results obtained during experiments carried out by the inventor.

While it is naturally preferable to install a sprinkler comprising a single ready-to-use assembly, nevertheless the sprinkler head can be adapted to fit into the lower case of prior-art units.

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

For simplicity of illustration the diagrams show only a single nozzle in use. However in some applications a second nozzle can be installed in the same housing as illustrated. The use of a fixed nozzle, usually configured to irrigate short range areas eases the task of the tiltable nozzle which then needs to cover only a smaller range.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a sectioned elevational view of a preferred embodiment of the sprinkler head showing a nozzle tilted at the highest available angle of tilt, according to the invention;

FIG. 2 is the same, showing a nozzle elevation at the lowest available angle of tilt.

FIG. 3 is an elevational view of a fixed sprinkler provided with a sprinkler head according to the invention;

FIG. 4 is an elevational view of a pop-up sprinkler seen extended and provided with a sprinkler head according to the invention;

FIG. 5 is an exploded view of the same embodiment;

FIGS. 6a and 6b are sectioned detail views showing how the flow rate is controlled at maximum and minimum nozzle elevation;

FIG. 7 is a view of a perspective view of the sleeve which carries the cam track;

FIG. 8 is a perspective view of one of the wedges which are inserted into the ridges of the sleeve; and

FIG. 9 is a schematic representation showing one of the wedges distorting the cam track in a desired formation.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

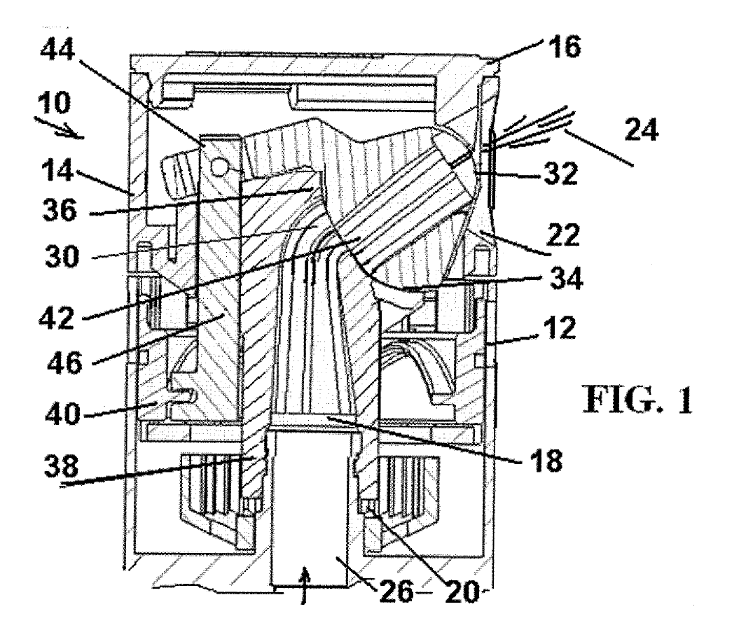

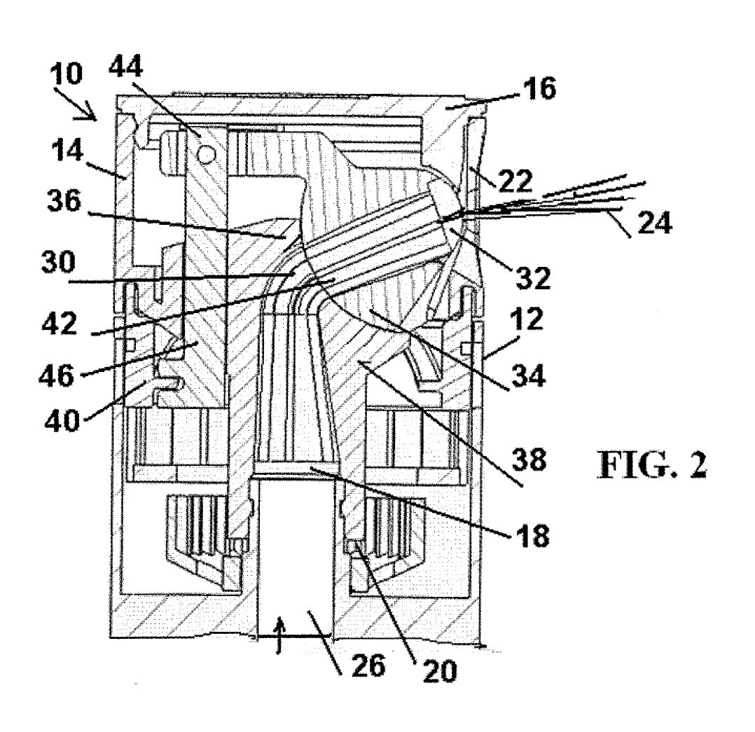

There is seen in FIGS. 1 and 2 an improved upper portion 10 of a programmable sprinkler arranged for even irrigation of a land area of regular or irregular shape. The upper portion 10 comprises a revolvable top spray outlet supported by a non-revolving mid portion 12. In FIG. 1 the sprinkler is seen irrigating a certain small area, while in FIG. 2 the sprinkler is irrigating to a greater distance thus covering area greater than that depicted in the setting of FIG. 1.

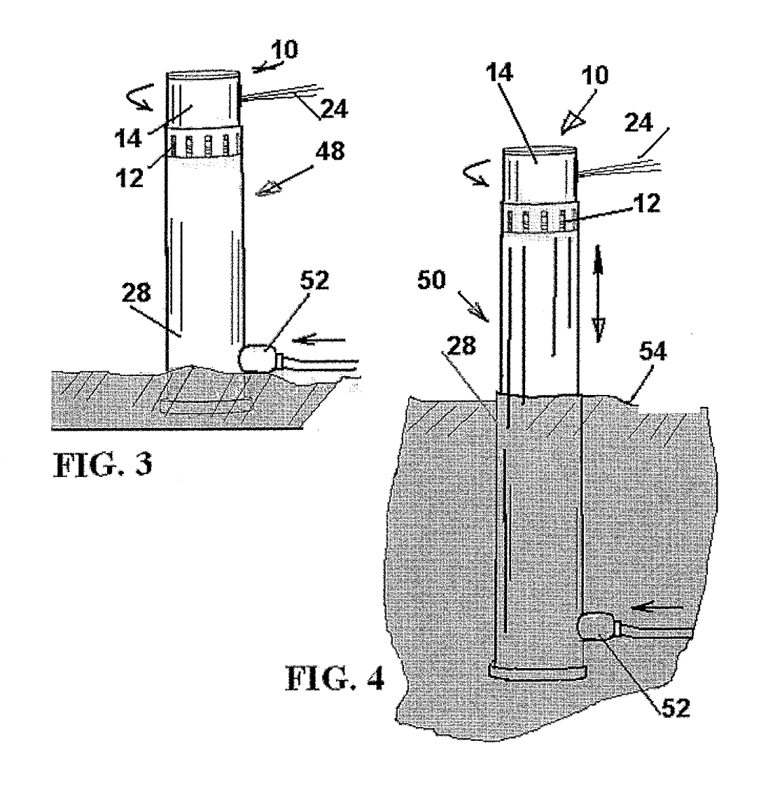

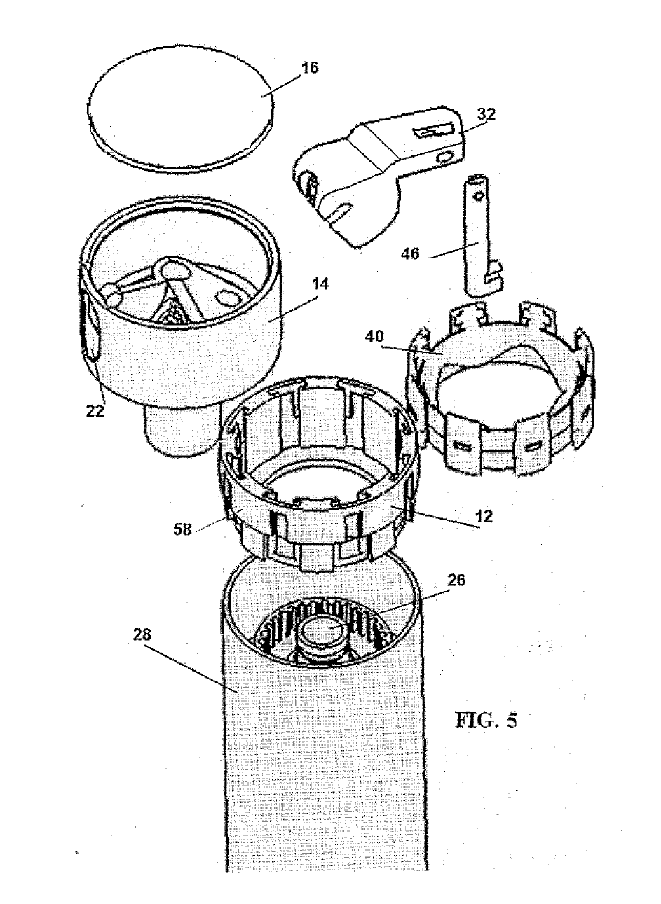

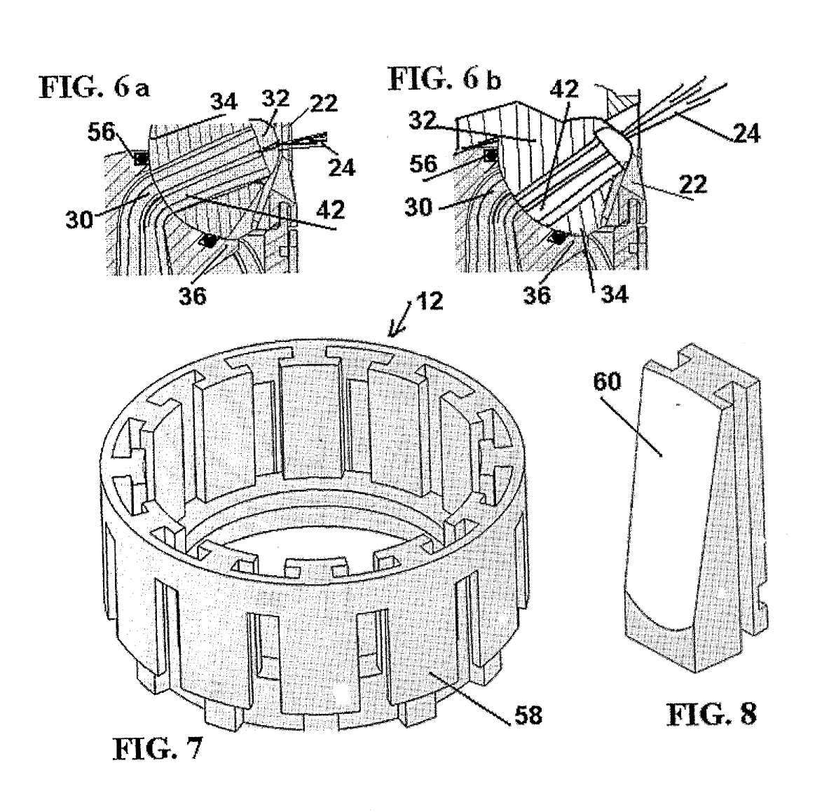

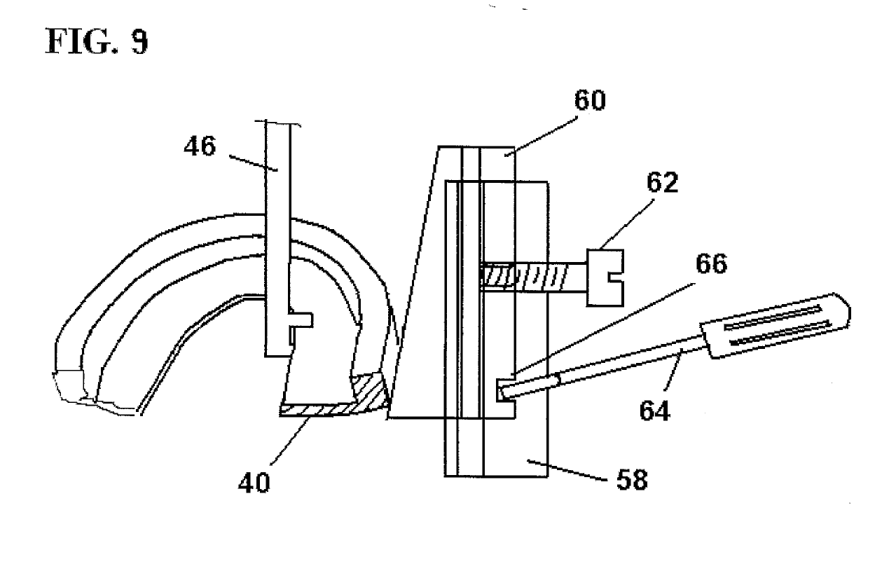

The top revolvable portion 10 comprises a housing 14 having a top closure 16 and a water inlet 18 at the center of its lower side. An elongated aperture 22 allows clearance for the passage of the water jet 24. A tube 26 in contact with the inlet 18 supplies water transmitting the rotary drive by cam track 40 suspended around tube 26, along a vertical axis. The drive is provided by a prior art water turbine which is not seen and for which no novelty is claimed. The turbine is operated by water entering a lower casing 28, seen in FIGS. 3 and 4.

The water inlet 18 is connected to an upper outlet 30 which supplies water to the spray nozzle. 32.

The spray nozzle 32 has an arcuate section 34 having the same radius as a concave portion 36 of the central revolvable element 38. One nozzle 32 is seen tiltably supported inside the upper revolvable housing 14. Additional nozzles, not shown, with or without tilting can also be disposed in the housing. The nozzle 32 shown in the drawing is seen free to slide along the concave portion 36. Such movement occurs when a follower arm 46 is raised and lowered due to its contact with the surface of cam track 40. The follower arm 46 thereby changes the elevational angle of the spray nozzle.

As is clearly evident from the drawings, the degree of alignment between the nozzle inlet port 42 relative to the water outlet port 30 of the central revolvable element 38 varies as a function of the angle at which the nozzle 32 is disposed relative to the horizontal. The advantages of this arrangement will be explained with reference to FIGS. 6a and 6B.

Sealing means are provided for the interfacing surfaces 34, 36 of the central revolvable element outlet 38 and nozzle inlet port 42. The Pressure of the O-ring on the nozzle inlet is provided by the water jet coming from the outlet port 30.

An adjustable cam track 40 is attached below the spray nozzle 32 to the non-revolvable mid section 12. The adjustable cam track 40 may be constructed of discrete strips, so that at least the edges of each strip overlap the edges of neighboring strips, to allow each strip to slide upon neighboring strips, so that each of the edges connecting point is free to move, up and down, vertically, relative to the neighboring connecting points, to create a cam track with a changeable shape. It would be appreciated by those skilled in the art that other structures may be used in order to allow the adjustment of the shape of cam track 40.

Adjustable cam track 40 is seen to better effect in FIGS. 5 and 9.

A cam adjustment means is provided, also shown in FIG. 9.

A cam follower connecting rod 46 is disposed partly inside the upper revolvable housing 14, and is in sliding or rolling contact at a lower extremity with the adjustable cam track 40. The upper extremity 44 of the connecting rod 46 is in hinged connection and revolves together with the spray nozzle 32.

With reference to the rest of the figures, similar reference numerals have been used to identify similar parts.

Referring now to FIG. 3, there is seen a complete projecting sprinkler unit 48. A water inlet 52 is seen near the base of the lower casing 28 with a water inlet 52. The casing 28 and the non-rotating mid portion 12 revolvably support an upper portion 10 in the housing 14 of a programmable sprinkler as described with reference to FIG. 1. The fixed sprinkler unit 48 is suitable for private gardens and in for use in public parks in areas where there is no access for pedestrians or for wheeled traffic.

FIG. 4 illustrates a complete pop-up sprinkler unit 50. The fixed base casing 28 is configured for under-ground installation. The casing 28 is dimensioned to allow the riser 50, the mid portion 12 and top portion 10 to retract to ground level. The mid portion 12 fits slidably into the lower casing 28 but does not revolve. Vertical upward movement of the mid sections 50 and 12 results from water under pressure entering the sprinkler. The mid and upper portions 10, 12 return by gravity; to a lower position flush with ground level 54 in response to disconnection of the water pressure.

Seen in FIG. 5 again shows the same embodiment 10 as was seen in FIG. 1, but showing further details thereof in the exploded view. In particular the cam track 40 is seen taking up a shape similar to a sine wave which is suitable for the irrigation of a rectangular area. It will be seen that the mid-portion 12 includes an outer sleeve 56 as will be seen in FIG. 7 and the cam track 40 fits therein.

Turning now to FIGS. 6a and 6b, there is depicted a detail of an embodiment provided with an ‘O’ ring 56 for enhanced sealing of the curved interface 34, 36 between the nozzle 32 and the central revolvable element 38. The ‘O’ ring 56 is made of a low-friction wear-resistant material, such as nylon, Teflon, urethane or silicon. Pressure of the water, exiting port 30 on the O ring, attaching the O-ring to the surface around inlet 42 of spray nozzle 32′ and providing a good sealing while maintaining low friction force.

Reference is now made to FIGS. 6a and 6b which are sectioned details views of a sprinkler head according to an embodiment of the present invention. FIGS. 6a and 6b show how the combination of the spray nozzle elevation and the flow rate controlled by the spray nozzle elevation, ensure equal water distribution per area unit for varying areas and varying perimeters. As may be seen in FIGS. 6A and 6B, when ports 30 and 42 are aligned, the water passage and thus the flow is highest, however, the angle of spray nozzle 32 is moderate relative to the horizon, thus allowing the watering of a larger area with a larger amount of water. When ports 30 and 42 are misaligned, when the angle of irrigation is increased, the flow rate is reduced due to the throttling of the water jet, however, since the angle of irrigation is increased relative to the horizon and to the angle of spray nozzle 32 of FIG. 6A, the size of the irrigated area is smaller and even distribution of water per area is maintained. This is achieved by changing the inter-alignment of ports 30 and 42, it will be clear that any intermediate elevation angle of the nozzle 32 brings about an appropriate degree of misalignment between the ports 30, 42 leading to even irrigation of the desired area. It would be appreciated by those skilled in the art that the throttling point along the water conduit leading to nozzle outlet must be in minimal distance from the spray nozzle outlet aperture in order to prevent water pressure dropping between the throttling point and the nozzle outlet and thus maintain the even water distribution as described above. According to one embodiment of the present invention the maximum distance between the throttling point and the spray nozzle outlet aperture is 18 mm. According to yet another embodiment, the maximum distance between the throttling point and the spray nozzle outlet aperture may be between 8-20 mm.

Referring now to FIG. 7, the mid section 12 of the sprinkler comprises a cam track holder sleeve 58, the adjustable cam track 40, seen in FIG. 9, a plurality of wedges 60 one of which is seen in FIG. 8, and lock screws 62 also seen in FIG. 9 having outwardly facing heads to retain the wedges 60 in a desired vertical position. The plurality of wedges 60 act as cam adjustment means by pressing on the adjustable cam track 40 and distorting the flat form thereof. Each wedge 60 can be individually slid to a desired height by engaging an outward facing recess 66 by means of a screwdriver or other tool and then locking the wedge position by means of screws 62.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meaning of the following claims.

What is claimed is:

1. An improved upper portion of a programmable sprinkler for even irrigation of a land area of regular or irregular shape, said upper portion comprising
a) an upper revolvable housing arranged to be revolved on a vertical axis driven by driving means, powered by water entering a lower casing, said upper revolvable housing being supported by a non-revolvable mid section provided with a water passage and further having
b) at least one spray nozzle tiltably supported inside said upper revolvable housing, the water jet inlet port of said spray nozzle being alignable to a water outlet port;
c) sealing means for the interfacing surfaces of said outlet and inlet ports;
d) an adjustable cam track attached below said spray nozzle to said non-revolvable mid section;
e) a plurality of cam track adjustment means provided with access from an external space to said cam track for changing the profile thereof; and
f) a connecting rod disposed, at least partly inside said upper revolvable housing, and being in sliding or rolling contact at a lower extremity with said adjustable cam track and at the upper extremity being in hinged or rigidly contact and revolving together with said spray nozzle.

2. A complete projecting sprinkler unit comprising a fixed base casing provided with a water inlet, said casing supporting an improved upper portion of a programmable sprinkler as claimed in claim 1.

3. A complete pop-up sprinkler unit comprising a fixed base casing configured for under ground installation provided with a water inlet, said casing slidingly supporting an improved upper portion of a programmable sprinkler as claimed in claim 1, said sprinkler having a non-revolvable vertically slidable mid section which is raised on a vertical axis by water under pressure entering said sprinkler and returned to its lower position flush with ground level in response to cessation of said water pressure.

4. The improved upper portion as claimed in claim 1, wherein the flow rate of said sprinkler is increased by automatic improvement of the alignment of said outlet and inlet ports when said nozzle is disposed at a shallow elevation to the horizontal, and automatically increases misalignment of said ports when said nozzle is disposed at a higher elevation to the horizontal.

5. The improved upper portion as claimed in claim 1, wherein said sealing means for the interfacing surfaces of said outlet and inlet ports comprises an elastomer low-friction O ring, pressure of the water on said O ring resulting the sealing between said interfacing surfaces and the central revolving element.

6. The improved upper portion as claimed in claim 1, wherein said plurality of cam adjustment means provided comprise wedge members which are disposed to contact with said adjustable cam track, said wedges being movable from outside said sprinkler and being lockable by means of screws, or any other mean having outwardly facing heads.

7. An improved upper portion of a programmable sprinkler for even irrigation of a land area of regular or irregular shape, substantially as described hereinbefore and with reference to the accompanying drawings.

8. The improved upper portion as claimed in claim 1, wherein the maximum distance between the throttling point and the spray nozzle outlet aperture is between 8-20 mm.

9. The improved upper portion as claimed in claim 1, wherein the maximum distance between the throttling point and the spray nozzle outlet aperture is 18 mm.
